(19) United States
(12) Patent Application Publication
(10) Pub. No.: US 2011/0255302 A1
(43) Pub. Date: Oct. 20, 2011

(54) LIGHT GUIDE PANEL ASSEMBLIES

(75) Inventors: PHILIP DAVID SHADBOLT, Bicester (GB); NIGEL ALASTAIR DENT, (US)

(73) Assignee: ZETA CONTROLS LIMITED, Bicester (GB)

(21) Appl. No.: 13/087,926

(22) Filed: Apr. 15, 2011

(30) Foreign Application Priority Data
Apr. 16, 2010 (GB) 1006375.8

(51) Int. Cl. F21V 7/22

(52) U.S. Cl. 362/606; 362/611; 362/613

(57) ABSTRACT

A light guide panel assembly (10) comprises a translucent panel (12), and at least one light-emitting device (40) (such as an LED) which projects a divergent beam of light into the panel from a light-receiving edge (52) of the panel. A heatsink (22) may be provided, with a compressible, thermally-conductive element (20) disposed in compression against the heatsink and so as to urge the light-emitting device(s) against the light-receiving edge of the panel and to provide a thermal pathway between the light-emitting device(s) and the heatsink. The compressible element therefore serves the dual purposes of holding the light-emitting device in place and also assisting in conducting heat away from it. The rear face (28) of the panel specularly reflects and scatteringly reflects light incident thereon from within the panel with a ratio of specular to scattering reflection which is preferably non-uniform across the rear face of the panel so as to cause substantially uniform illumination of the front face (58) of the panel.

### BACKGROUND OF THE INVENTION

This invention relates to light guide panel assemblies.

Such panel assemblies can be used to provide illuminated signs, such as road signs, which may convey a message by virtue of their shape or by masking provided on the panel assembly. They may also be used for back-lighting of displays such as liquid crystal computer screens or television screens.

A conventional panel assembly of this type comprises a translucent panel (for example of acrylic) and at least one light-emitting device (such as an light emitting diode, or LED) arranged for producing a divergent beam of light and projecting the light into the panel from a light-receiving edge of the panel. As the light passes through the panel, it is internally reflected by the front and rear faces of the panel and at least some of the light is transmitted by at least one light-emitting surface portion of at least one of the faces so as to illuminate that surface portion. At least one other surface portion of that face may be opaque so that an illuminated pattern is formed on that face. Alternatively, substantially all of one or each face may be light-emitting, so that the whole face (which may have a particular shape such as a direction arrow) is illuminated.

Although high-power LEDs are reasonably efficient at converting electrical energy into light energy, they do produce heat and can become hot. The hotter the temperature at which an LED is run, the shorter its life. It is therefore desirable to conduct the heat away from the LED.

It is desirable that the light emitting device(s) and any other electrical components contained in the panel assembly are protected against the ingress of moisture.

It is also desirable that the light-emitting face of the panel assembly provides uniform illumination (other than in areas where the face is intended to be masked). However, generally speaking, the further the light travels through the panel from the light-emitting device, the less intense it becomes. Also, if the light-emitting device(s) are not properly positioned, for example being canted over, they can produce aberrations in the illumination.

### BRIEF SUMMARY OF THE INVENTION

An aim of the present invention, or at least of specific embodiments of it, is to provide a light guide panel assembly which can: conduct heat effectively away from the light-emitting device(s); establish and maintain proper positioning of the light emitting device(s); provide a seal against ingress of moisture to the light-emitting devices; provide substantially uniform illumination of the light-emitting face of the panel assembly (other than in areas where the face is intended to be masked); and accomplish all of the aforesaid in a simple, convenient and inexpensive manner.

In accordance with a first aspect of the present invention, there is provided a light guide panel assembly comprising: a translucent panel; a light-emitting device (such as an LED) arranged for producing a divergent beam of light and projecting the light into the panel from a light-receiving edge of the panel; a heatsink; and a compressible, thermally-conductive element disposed in compression against the heatsink and so as to urge the light-emitting device against the light-receiving edge of the panel and to provide a thermal pathway between the light-emitting device and the heatsink. The compressible element therefore serves the dual purposes of holding the light-emitting device in place and also assisting in conducting heat away from it. In some embodiments, it can also serve as a seal to prevent ingress of moisture to the light-emitting device.

The light emitting device is preferably one of a plurality of such light-emitting devices mounted on one face of a common, elongate circuit board, and the compressible element is preferably elongate and is compressed against the heatsink and an opposite face of the circuit board.

The light-receiving edge of the panel may include at least a portion which is not straight, in which case the circuit board is preferably flexible and conforms to the shape of the light-receiving edge of the panel. This conveniently enables complex shapes of panel assembly to be provided.

The circuit board may have connection pads at each end of the circuit board, so that a plurality of the circuit boards can be daisy-chained together in a single panel assembly and/or in separate panel assemblies.

The light-receiving edge of the panel is preferably formed by a side wall of a groove formed in one face of the panel, the light-emitting device(s) and compressible element being disposed in the groove, therefore enabling the opposite face of the panel to be uninterrupted. In this case, the compressible element is preferably disposed in compression against a bottom wall of the groove and against an opposite side wall of the groove, with the heatsink closing off the groove at the rear face of the panel.

A front face of the panel preferably has at least one light-emitting surface portion which specularly reflects and transmits light incident thereon from within the panel, and a rear face of the panel preferably specularly reflects and scatteringly reflects light incident thereon from within the panel. This enables the panel to act as a light guide and to illuminate the front face.

The rear face of the panel preferably specularly reflects and scatteringly reflects light incident thereon from within the panel with a ratio of specular to scattering reflection which is non-uniform across the rear face of the panel, preferably so as to cause substantially uniform illumination of the front face.

This latter feature may be provided independently of other features of the first aspect of the invention. Therefore, in accordance with a second aspect of the invention, there is provided a light guide panel assembly comprising a translucent panel and a light-emitting device arranged for producing a divergent beam of light and projecting the light into the panel from a light-receiving edge of the panel, wherein: a front face of the panel has at least one light-emitting surface portion which specularly reflects and transmits light incident thereon from within the panel; and a rear face of the panel specularly reflects and scatteringly reflects light incident thereon from within the panel with a ratio of specular to scattering reflection which is non-uniform across the rear face of the panel.

The non-uniform reflection ratio may be provided by the rear face of the panel having a smooth surface interrupted by surface irregularities having a density which is non-uniform across the rear face of the panel. In particular, the surface irregularities may have depths which are non-uniform across the rear face of the panel and/or pitches relative to adjacent irregularities which are non-uniform across the rear face of panel. The surface irregularities may be formed by grooves in the rear surface of the panel. The grooves may be substantially straight and parallel, especially in the case of a rectangular panel illuminated along one edge, and/or they may be curved and/or non-parallel and/or non-concentric in the case of more complex shapes of panel.

The panel assembly preferably further includes a scatteringly reflective surface disposed against the rear face of the panel so that any light that escapes through the rear face is reflected back to the rear face. In the case where a heatsink is provided, the scatteringly reflective surface may be provided by the heatsink.

The or each light-emitting surface portion of the front face of the panel preferably (a) specularly reflects substantially all light incident thereon from within the panel at an angle of incidence greater than the critical angle; and (b) transmits substantially all light incident thereon from within the panel at an angle of incidence less than the critical angle.

### BRIEF DESCRIPTION OF THE SEVERAL VIEWS OF THE DRAWING

FIG. 1 is an exploded isometric view of a first embodiment of light guide panel assembly with its centre portion cut away;

FIG. 2A-C are sectioned side views of the light guide panel assembly of FIG. 1, exploded in FIG. 2A, partly assembled in FIG. 2B, and fully assembled in FIG. 2C;

FIGS. 3A-D are side views of the panel assembly of FIGS. 1 and 2 showing sample light rays resulting in emission of light from four different regions on a front face of the panel assembly;

FIGS. 4A & B are side views on a larger scale showing two different arrangements of surface irregularities on two portions of the rear face of the panel assembly;

FIGS. 5A & B are a sectioned side view and a sectioned underplan view, respectively, of a second embodiment of light guide panel assembly;

FIGS. 6A & B are a sectioned side view and a sectioned underplan view, respectively, of a third embodiment of light guide panel assembly; and

FIG. 7 is an isometric view of a modified printed circuit board assembly for use in the embodiments of the invention.

### DETAILED DESCRIPTION OF THE INVENTION

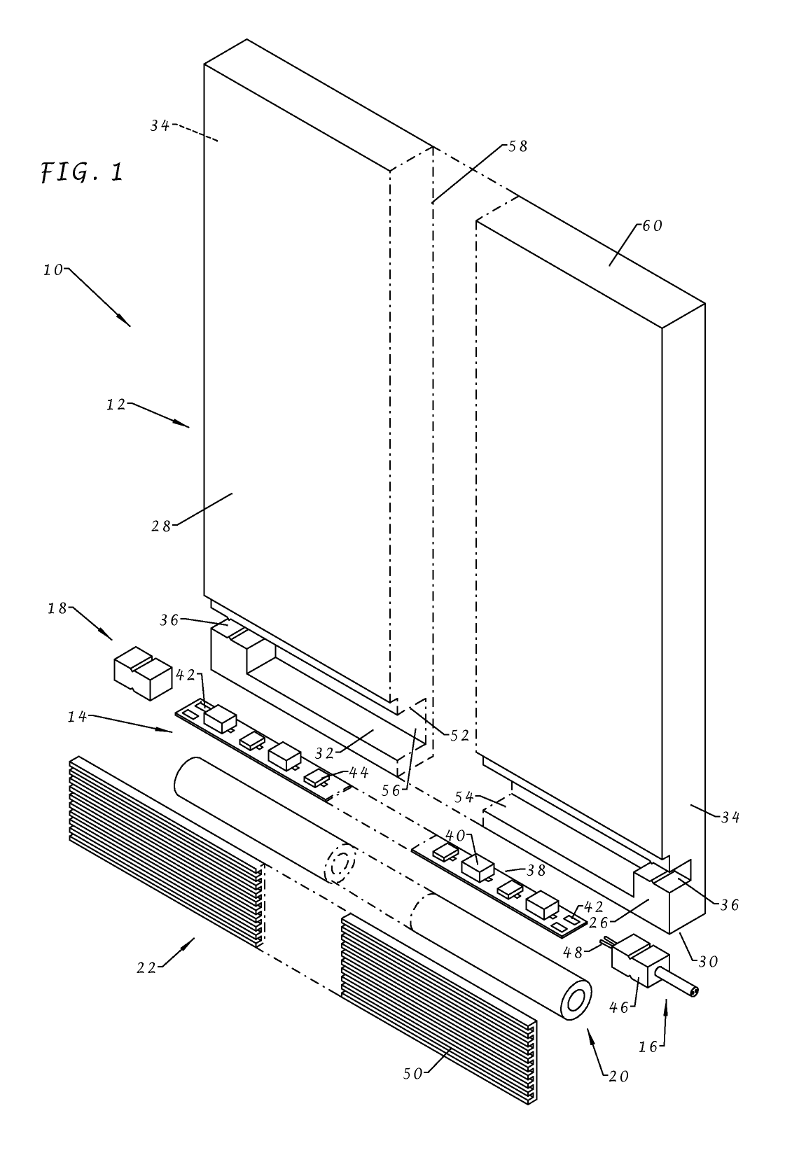

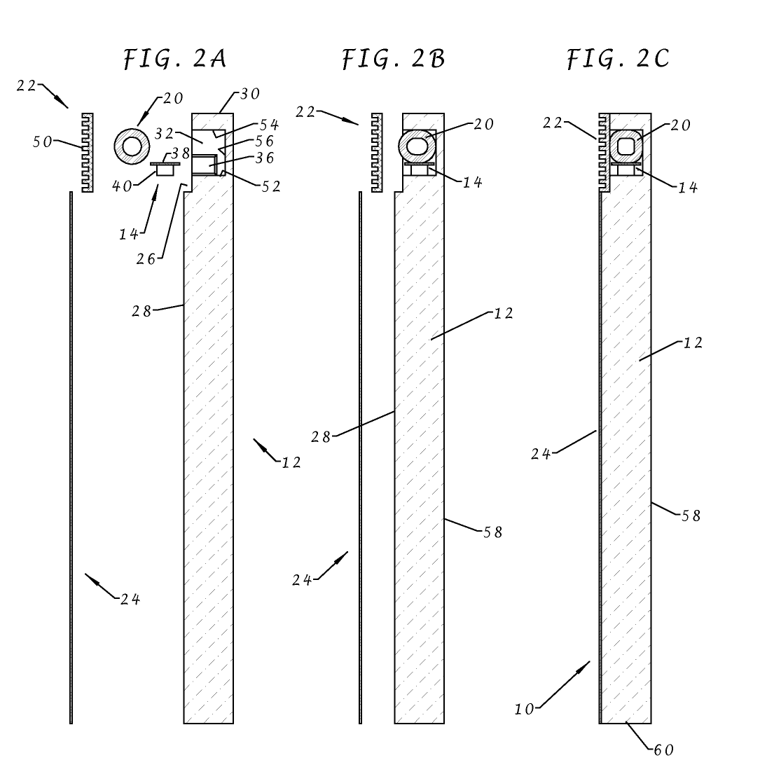

Referring to FIGS. 1 to 2C, the first embodiment of light guide panel assembly 10 comprises a panel 12, a printed circuit board (PCB) assembly 14, a two-core connection lead 16, a blanking plug 18, a compression element 20, a heatsink 22 and a backing sheet 24 (not shown in FIG. 1).

The panel 12 is generally rectangular and is made of acrylic. A rabbet 26 is formed in the rear face 28 and one edge 30 of the panel 12. A deep groove 32 is formed in the rabbeted portion of the panel 12 and extends almost to the ends 34 of the panel 12. The innermost edge 52 of the deep groove 32 is preferably polished Smaller grooves 36 are formed between the ends of the deep groove 32 and the ends 34 of the panel 12.

The PCB assembly 14 comprises a flexible PCB 38 made from Kapton® or similar material. The PCB 38 is in the form of a strip having a length slightly less than the length of the groove 32 in the panel 12 and a width slightly less than the depth of the groove 32 in the panel 12. A plurality of flat-faced surface-mount LEDs 40 are mounted on the PCB 38. The PCB 38 has a pair of connecting pads 42 at each of its ends. The PCB 38 may also carry other components 44 such as voltage-dropping resistors and/or current regulators. The LEDs 40, connecting pads 42 and other components 44 are connected by tracks (not shown) of the PCB 38 so that when the connecting pads 42 at one end of the PCB 38 are connected to a electrical supply of a particular voltage and polarity, an appropriate electrical current passes through each LED 40 to illuminate it, and also the supply voltage is fed to the connecting pads 42 at the opposite end of the PCB 38.

The connection lead 16 has a moulded resilient grommet 46 adjacent one end which is a tight fit in the smaller groove 36 at one end 34 of the panel 12 and which naturally protrudes slightly above the groove 36. During assembly of the panel assembly 10, the cores 48 of the lead 16 are soldered to the connecting pads 42 at the adjacent end of the PCB 38. The other end of the lead 16 is connected to an electrical supply, such as a battery pack or a mains-to-DC adapter. The blanking plug 18 is a tight fit in the smaller groove 36 at the opposite end 34 of the panel 12 and naturally protrudes slightly above the groove 36. As an alternative to using the blanking plug 18, the smaller groove 36 at that end 34 of the panel 12 may be omitted. Alternatively, a further connection lead may be fitted similarly to the connection lead 16 and soldered to the connecting pads 42 at the adjacent end of the PCB 38 so that electricity can be fed to another light guide panel assembly.

The compression element 20 is a tubular O-rope formed from doped silicone rubber which is resilient, has a high thermal conductivity and is waterproof. For example, the compression element may be made of Primasil PR910/1388 available from Primasil Silicones, HR4 8QU, United Kingdom, and having a thermal conductivity of about 1.5 W·m⁻¹·K⁻¹. The length of the compression element 20 is slightly longer than the length of the deep grove 32.

The compression element 20 has an outer diameter which is slightly greater than the depth of the deep groove 32 and slightly greater than the width of the deep groove 32 less the height of the PCB assembly 14.

The heatsink 22 is formed from a plate of aluminium alloy having a width equal to the width of the rabbet 26 and a length equal to the length of the panel 12 between its ends 34. The heatsink 22 may be plain or (as shown) it may be formed with fins 50 on one face.

The backing sheet 24 is formed from plastics film having a matt-white self-adhesive surface. The backing sheet 24 is the same size as the rear non-rabbeted portion of the panel 12.

Referring in particular to FIGS. 2A & B, during assembly of the panel assembly 10, the PCB assembly 14 is placed in the deep groove 32 with the light-emitting faces of the LEDs 40 abutting the polished innermost edge 52 of the deep groove 32, and the grommet 46 of the connection lead 16 and the blanking plug 18 are squeezed into the smaller grooves 36. The compression element 20 is then squeezed into the deep groove 32 so that it abuts the rear of the PCB assembly 14, the outermost edge 54 of the groove 32 and the bottom 56 of the groove 32. As can be seen in FIG. 2B, the compression element 20 naturally protrudes from the deep groove 32. Then, adhesive is applied to the plain face of the heatsink 22 and/or to the rabbet 26, and the heatsink 22 is pressed into the rabbet 26 so as to compress the compression element 20 into the deep groove 32, as shown in FIG. 2C, and also compress the grommet 46 and blanking plug 18 into the smaller grooves 36. External pressure is maintained until the adhesive has cured. Also, as shown in FIG. 2C, the backing sheet 24 is adhered to the rear non-rabbeted portion of the panel 12.

It will therefore be appreciated that the thermally-conductive compression element 20 urges itself into good contact with the rear of the PCB assembly 14 and the heatsink 22 so as to provide a good thermal path between the two. The compression element 20 also urges the light-emitting faces of the LEDs 40 into contact with the edge 52 of the groove 32. Moreover, the compression element 20 serves to prevent any moisture which enters between the panel 12 and the heatsink 22 at the edge 30 of the panel 12 from reaching the PCB assembly 38.

In operation, the LEDs 40 each produce a divergent beam having a viewing half-angle of, for example, 30 to 40 degrees and possibly greater. The acrylic material of the panel 12 has a refractive index of about 1.49, and therefore the critical angle at the acrylic-air interface is about 42 degrees. The front face 58 of the panel 12 is polished so that:
substantially all light incident on the front face 58 from within the panel 12 is specularly reflected if the angle of incidence is greater than the critical angle;
substantially all light incident on the front face 58 from within the panel 12 is transmitted out of the panel if the angle of incidence is less than the critical angle; and
no substantial amount of light incident on the front face 58 from within the panel 12 is scatteringly reflected.
   By contrast, the rear face 28 of the panel 12 has a degree of mattness which is non-uniform over the rear face so that, depending on the position on the rear face 28:
a proportion of light incident on the rear face 28 from within the panel 12 is specularly reflected; and
a proportion of light incident on the rear face 28 from within the panel 12 is specularly reflected either directly or by being transmitted through the rear face 28 and then being specularly reflected back to the panel 12 by the matt white surface of the backing sheet 24.

The outer edge 60 of the panel 12 remote from the LEDs 40 may be substantially totally absorbent to light or may be slightly reflective. The sides 34 of the panel are preferably reflective.

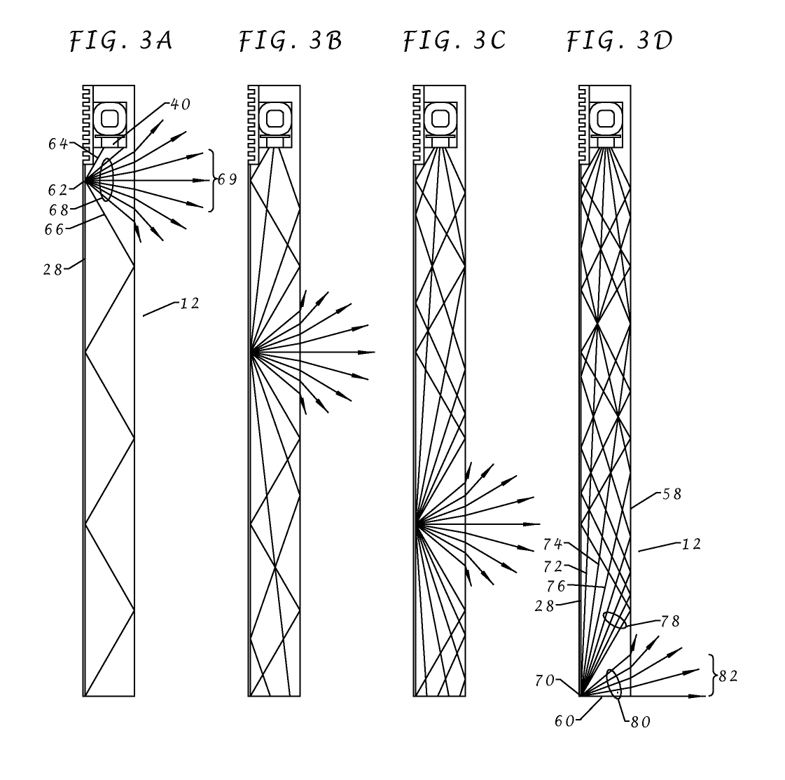

Referring to FIGS. 3A-D and considering only light rays travelling in the plane of the paper, it will be seen that at a point 62 (FIG. 3A) on the rear face 28 of the panel 12 adjacent the LED 40, substantially the only incident light is a high intensity ray 64 received directly from the LED 40. A proportion of this light (i.e. of lower intensity than the ray 64) is specularly reflected, as shown by ray 66, and a proportion is scatteringly reflected, as shown by the rays 68, and illuminates the panel 12 in the region 69. By contrast, at a point 70 (FIG. 3D) on the rear face 28 of the panel 12 adjacent the far edge 60 of the panel 12, the incident light comprises:
a ray 72 received directly from the LED 40;
a ray 74 received after one specular reflection from the front face 58;
a ray 76 received after one reflection from the rear face 28 and one specular reflection from the front face 58; and
a number of other rays 78 received after multiple reflections from the front and rear faces 58,28 of the panel 12.

Each of these rays 72-78 is of lower intensity than the ray 64 received at point 62

(FIG. 3A) due to the greater distance from the LED 40. Furthermore, the intensity of the rays 76,78 is further reduced due to the scattering reflections which occurred at the rear face 28 of the panel 12. Preferably, at the point 70 adjacent the far edge 60, the rear face 28 of the panel 12 is totally matt, so that none of the rays 72-78 is specularly reflected, in which case all of the rays 72-78 are scatteringly reflected as shown by the rays 80, and illuminate the panel in the region 82.

To a first order approximation, the intensity of the ray 64 incident on the point 62 adjacent the LED 40 is substantially greater than the total intensity of the rays 72-78 incident on point 70 adjacent the far edge 60 of the panel 12. Therefore, the rear face 28 of the panel 12 needs to be substantially more glossy (i.e. specularly reflect a greater proportion of light) at point 62 than at point 70 in order that the illumination provided by the rays 68 in region 69 is substantially equal to the illumination provided by the rays 80 in region 82. Indeed, to a first order approximation, the required glossiness of the rear face 28 of the panel 12 is related to the inverse of the distance from the LED 40. However, other factors affect uniform illumination of the front face 58 of the panel 12, notably the radiation pattern of the LEDs 40 (i.e. the variation of intensity with viewing angle) and edge effects. Therefore, the non-uniformity of glossiness of the rear face 28 of the panel 12 that is required in order to achieve uniform illumination of the front face 58 of the panel 12 is best determined by trial and error.

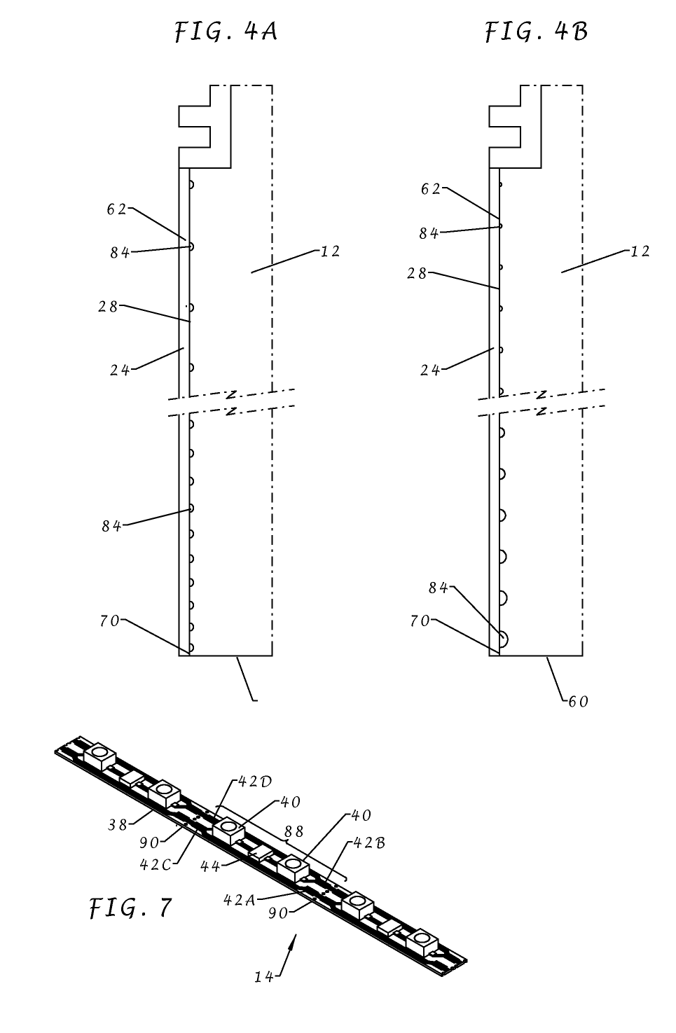

The non-uniform glossiness of the rear face 28 of the panel 12 may be achieved in a number of ways. For example, discrete formations may be provided in the rear face 28, such as grooves cut or laser-engraved into the rear face 28. FIG. 4A shows an example where parallel grooves 84 of a particular depth are formed in the rear face 28, and the pitch between adjacent grooves progressively decreases from the point 62 near the LED 40 to the point 70 near the far edge 60 of the panel 12 parallel grooves 84 of the particular depth but a smaller pitch are formed in the rear face 28. FIG. 4B shows an example where parallel grooves 84 of a particular pitch are formed in the rear face 28, and the depth of the grooves 84 progressively increases from the point 62 near the LED 40 to the point 70 near the far edge 60 of the panel 12. It will be appreciated that the arrangements of FIGS. 4A and 4B may be combined to provide for surface irregularities with both a non-uniform pitch and a non-uniform depth.

Instead of providing discrete regular formations, the glossiness of the rear face 28 may also be rendered non-uniform by other treatments, such as rubbing the face 28 with a rotating wire wheel with varying pressure being applied, rubbing the face 28 with varying grades of abrasive paper, or sand-blasting the rear face 28 with varying exposure times.

In the first embodiment described above, the panel 12 is rectangular. However, the panel may have any regular or irregular shape.

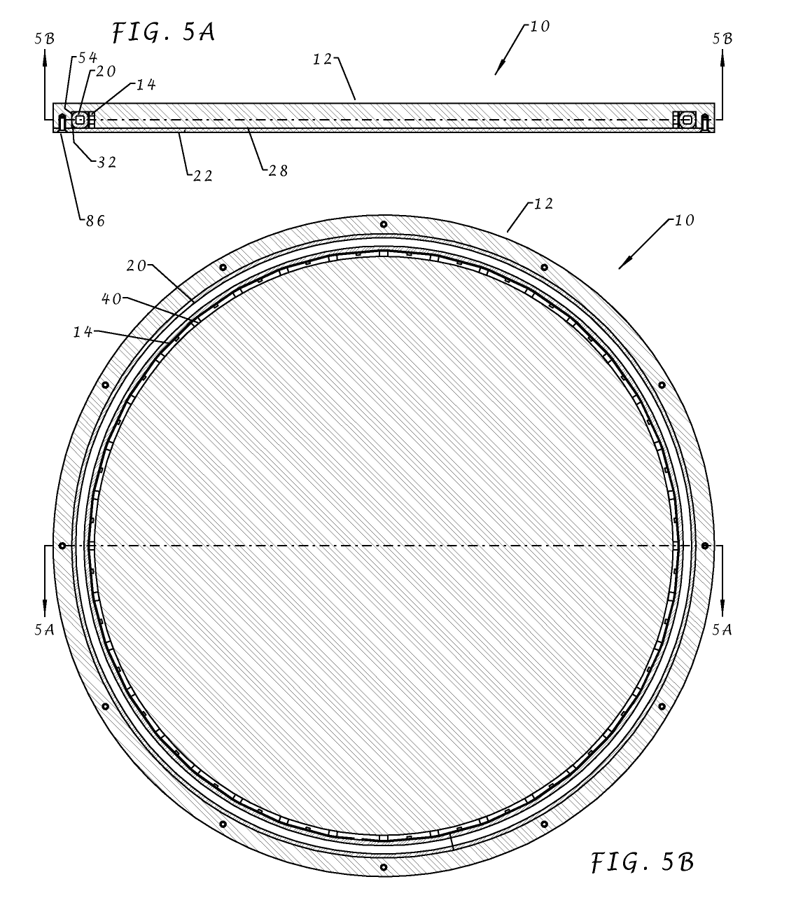

For example, FIGS. 5A & B show a second embodiment of the invention with a circular panel 12 having a circular groove 32 for the PCB assembly 14 and compression element 20. Because the PCB 38 and compression element 20 are flexible, they can both readily be formed into circles. The heatsink 22 of the second embodiment is a plain circular disc which is secured to the rear of the panel 12 by screws 86. It will be noted that because the compression element 20 engages both the plate of the heatsink 22 and the outer edge of the groove 32, the compression element 20 prevents the ingress of any moisture into the region occupied by the PCB assembly 14. At least the face of the plate of the heatsink 22 facing the panel 12 is finished as matt white so as to serve the same function as the backing sheet 24 in the first embodiment of the invention. The connection lead (not shown) in the second embodiment may enter the panel through a grommet in the plate of the heatsink 22 or in the outer wall of the groove 32. Because of the circular shape of the panel 12, the required non-uniformity of the glossiness of the rear face 28 of the panel 12 in order to achieve uniform illumination may be less pronounced than in the case of the first embodiment. The non-uniformity will be rotationally symmetrical through any angle about the centre of the panel 12.

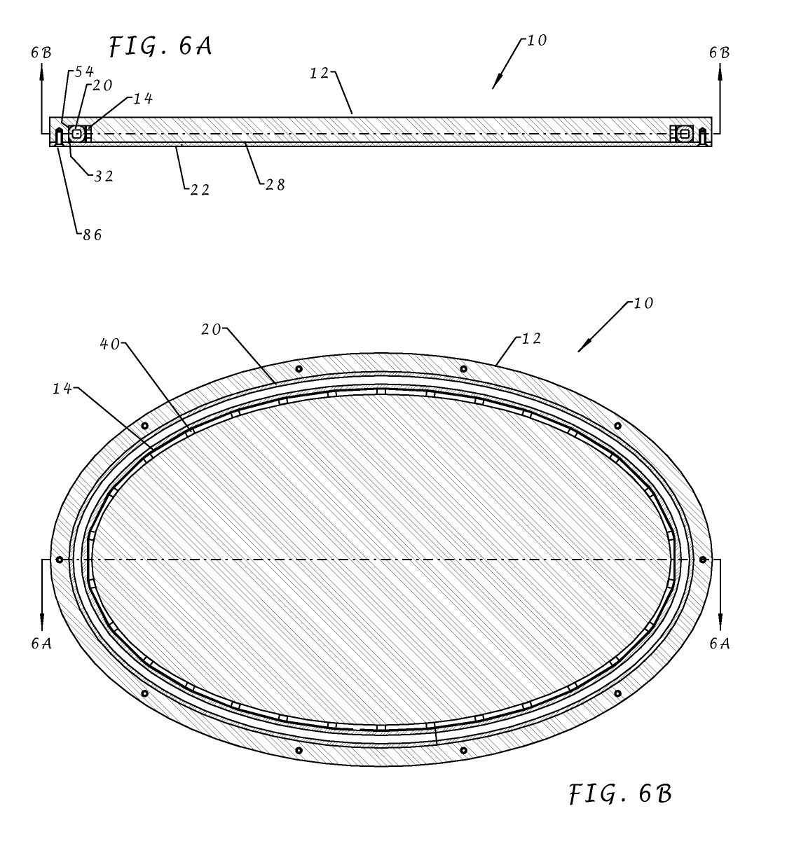

FIGS. 6A & B show a third embodiment of the invention which is similar to the second embodiment except that the panel 12 is elliptical. In this case, the required non-unifomity of the glossiness of the rear face 28 of the panel 12 will be more complex than in the first and second embodiments but can be ascertained by trial and error.

FIG. 7 shows more detail of a PCB assembly 14 which may be used in the embodiments of the invention. As described above, the PCB assembly 14 comprises a flexible PCB 38 made from Kapton®. The PCB 38 is in the form of a strip many metres long and is divided up into identical sections 88 (three of which are shown in FIG. 7) separated by perforated break lines 90. Each section 88 comprises two connecting pads 42A,B at one end and two connecting pads 42C,D at the opposite end. In each section 88, the tracks of the PCB 38 connect: pad 42A to pad 42C; pad 42B to pad 42D; and pad 42B to pad 42C via a plurality of LEDs 40 and a current regulator 44 in series. Also, across each break line 90, the tracks of the PCB 38 connect: pads 42A and 42C of the adjacent sections 88; and pads 42B and 42D of adjacent sections. The PCB assembly 14 can therefore be cut or snapped apart along a break line 90 to form any desired length of assembly 14 which is an integer multiple of the length of each section 88. The electricity supply can then be connected to the pads 42A,B at one end of the length of PCB assembly 14, and the pads 42C,D at the opposite end may be left unconnected, connected to another PCB assembly 14 or connected back to the pads 42A,B at the first end in a ring. Each current regulator 44 serves to regulate the current through the LEDs 40 in its section 88 to a desired value provided that the voltage supplied to the section 88 is sufficiently high for the regulator 44 not to drop out and provided the supply voltage is not too high to overload the regulator 44. Uniform illumination of the LEDs 40 can therefore be achieved despite variation in the supply voltage, voltage drops along the length of the PCB assembly 14, and the number of sections 88 in the PCB assembly 14.

In a modification to the PCB assembly 14 of FIG. 7, the current regulators 44 are adjustable, and further interconnected connecting pads are provided at each end of each section 88 for receiving a control voltage and supplying the control voltage to each current regulator 44.

In all of the embodiments described above, the panel 12 may be clear or tinted. Also, the front face 58 of the panel 12 may be unmarked so that substantially the whole of the panel 12 is illuminated. Alternatively, the front face 58 of the panel may be masked with an opaque or contrastingly-coloured graphic in a conventional manner The colours of the LEDs 40 may be chosen to suit the colours of the graphic. The LEDs 40 may be driven to provide a flashing sign, and a dimming arrangement may be provided, which may be responsive to ambient light. The panel assembly 10 may be incorporated into another structure.

It should be noted that the embodiments of the invention has been described above purely by way of example and that many other modifications and developments may be made thereto within the scope of the present invention.

1. A light guide panel assembly comprising:
a translucent panel having a light-receiving edge;
a light-emitting device arranged for producing a divergent beam of light and projecting the light into the panel from the light-receiving edge of the panel;
a heatsink; and
a compressible, thermally-conductive element disposed in compression against the heatsink and so as to urge the light-emitting device against the light-receiving edge of the panel and to provide a thermal pathway between the light-emitting device and the heatsink.

2. A light guide panel assembly as claimed in claim 1, wherein:
the assembly further includes an elongate circuit board having first and second faces;
the light emitting device is one of a plurality of such light-emitting devices mounted along the first face of the circuit board; and
the compressible element is elongate and is compressed against the heatsink and the second face of the circuit board.

3. A light guide panel assembly as claimed in claim 2, wherein:
the light-receiving edge of the panel includes at least a portion which is not straight; and
the circuit board is flexible and conforms to the shape of the light-receiving edge of the panel.

4. A light guide panel assembly as claimed in claim 2, wherein:
the circuit board has connection pads at each end of the circuit board.

5. A light guide panel assembly as claimed in claim 1, wherein:
a groove is formed in one face of the panel, the groove having a first side wall;
the light-receiving edge of the panel is formed by the first side wall of groove; and
the light-emitting device(s) and compressible element are disposed in the groove.

6. A light guide panel assembly as claimed in claim 5, wherein:
the groove has a bottom wall and a second side wall opposite the first side wall;
the compressible element is disposed in compression against the bottom wall and the second side wall of the groove; and
the heatsink closes the groove.

7. A light guide panel assembly as claimed in claim 1, wherein:
the panel has a front face and a rear face;
the front face of the panel has at least one light-emitting surface portion which specularly reflects and transmits light incident thereon from within the panel;
the rear face of the panel specularly reflects and scatteringly reflects light incident thereon from within the panel.

8. A light guide panel assembly as claimed in claim 7, wherein:
the rear face of the panel specularly reflects and scatteringly reflects light incident thereon from within the panel with a ratio of specular to scattering reflection which is non-uniform across the rear face of the panel.

9. A light guide panel assembly as claimed in claim 8, wherein:
the rear face of the panel has a smooth surface interrupted by surface irregularities having a density which is non-uniform across the rear face of the panel.

10. A light guide panel assembly as claimed in claim 9, wherein:
the surface irregularities are formed by grooves in the rear surface of the panel.

11. A light guide panel assembly as claimed in claim 7, further including:
a scatteringly reflective surface disposed against the rear face of the panel.

12. A light guide panel assembly as claimed in claim 11, wherein:
the scatteringly reflective surface is provided by the heatsink.

13. A light guide panel assembly as claimed in claim 7, wherein:
the or each light-emitting surface portion of the front face of the panel:
specularly reflects substantially all light incident thereon from within the panel at an angle of incidence greater than the critical angle; and
transmits substantially all light incident thereon from within the panel at an angle of incidence less than the critical angle.

14. A light guide panel assembly comprising:
a translucent panel having a light-receiving edge, a front face and a rear face; and
at least one light-emitting device arranged for producing a divergent beam of light and projecting the light into the panel from the light-receiving edge of the panel;
wherein:
the front face of the panel has at least one light-emitting surface portion which specularly reflects and transmits light incident thereon from within the panel; and
the rear face of the panel specularly reflects and scatteringly reflects light incident thereon from within the panel with a ratio of specular to scattering reflection which is non-uniform across the rear face of the panel.

15. A light guide panel assembly as claimed in claim 14, wherein:
the rear face of the panel has a smooth surface interrupted by surface irregularities having a density which is non-uniform across the rear face of the panel.

16. A light guide panel assembly as claimed in claim 15, wherein:
the surface irregularities have depths which are non-uniform across the rear face of the panel.

17. A light guide panel assembly as claimed in claim 15, wherein:
the surface irregularities have a pitches relative to adjacent irregularities which are non-uniform across the rear face of panel.

18. A light guide panel assembly as claimed in claim 15, wherein:
the surface irregularities are formed by grooves in the rear surface of the panel.

19. A light guide panel assembly as claimed in claim 14, further including:
a scatteringly reflective surface disposed against the rear face of the panel.

20. A light guide panel assembly as claimed in claim 14, wherein:
the or each light-emitting surface portion of the front face of the panel:
specularly reflects substantially all light incident thereon from within the panel at an angle of incidence greater than the critical angle; and
transmits substantially all light incident thereon from within the panel at an angle of incidence less than the critical angle.
